(19) United States
(12) Patent Application Publication
(10) Pub. No.: US 2015/0186840 A1
(43) Pub. Date: Jul. 2, 2015

(54) SMART LOCKER SYSTEM AND METHOD OF PARCEL DELIVERY

(71) Applicants: Lori TORRES, Coto De Caza, CA (US); Brian SUGGS, Irvine, CA (US)

(72) Inventors: Lori TORRES, Coto De Caza, CA (US); Brian SUGGS, Irvine, CA (US)

(21) Appl. No.: 14/582,088

(22) Filed: Dec. 23, 2014

Related U.S. Application Data
(60) Provisional application No. 61/920,387, filed on Dec. 23, 2013.

(51) Int. Cl. G06Q 10/08; A47B 81/00; H05K 5/00; A47F 10/02

(52) U.S. Cl. CPC G06Q 10/0836; A47F 10/02; A47B 81/00; H05K 5/0017

(57) ABSTRACT

Exemplary Electronic Smart Locker compartments may be used for the ease, convenience, and security of delivering and retrieving parcels. Each locker station may include a set of individual lockers of various sizes, each with an electronic controlled release operated door latch. Each locker station has an input/output device(s) that is electronically connected to an internal computer. The input/output device(s) permits control of the smart locker system to deliver and retrieve parcels. The computer and software are used to store, retrieve and manipulate delivery courier and parcel recipient pertinent information and parcel delivery tracking information.

### PRIORITY

This application claims priority to U.S. Provisional Application No. 61/920,387, filed Dec. 23, 2013, which is incorporated by reference in its entirety into this application.

### FIELD

This invention is in the field of receiving and delivery of parcels utilizing a computerized Electronic Smart Locker system.

### BACKGROUND

The growth of apartment communities across the nation coupled with the increase in on-line shopping has created a need for an efficient parcel distribution system that is beneficial to the apartment resident, the apartment owner and/or landlord and the parcel delivery services.

A persistent problem exists throughout the apartment community industry related to the volume of packages that are delivered on a daily basis to the management offices. A leasing office can accept 25-250 packages per day on behalf of the residents and can spend between one and three hours per day managing these packages.

The standard method of parcel delivery to an apartment community now includes using property management staff members. When a resident is not home to accept a package, the courier can deliver it to the on-site property management office to be picked up when the resident returns. Other options for the couriers would be to return the package to the shipping facility or leave it unattended at the resident's door. The option of returning it to the shipping facility is an inconvenience to the resident, who must go and pick it up. The other option of leaving an unattended package at the door invites the opportunity of parcel theft, which has been on the rise. Even with the additional time required to manage the packages, the property managers have offered to accept the packages from the couriers in an effort to bypass the other options which could negatively impact their tenants.

When the package is left at the on-site property management office, the disadvantage for the resident is that the package can only be picked-up during office hours. Given the long work hours and alternate work schedules of many residents, restricting parcel pick up during property management office hours can be an inconvenience.

A variety of locker delivery systems currently exist. For example, systems are described in U.S. Pat. Pub. 2002/0156645 (Hansen), U.S. Pat. No. 6,791,450 (Gokcebay et al.), U.S. Pat. No. 4,894,717 (Komei) and U.S. Pat. No. 5,475,378 (Kaarsoo, et al.).

The system described in Hansen's patent is a free-standing, multi-compartment kiosk used in the delivery and pick-up of parcels. The kiosk is electronically connected to a computer that processes the information related to the delivery person and recipient. Hansen's system is internet-based and is dependent upon on-line retailers and delivery companies' cooperation and/or partnership. The user is required to purchase a membership from the kiosk company and provide credit card information for purchasing on-line products. After making an on-line purchase, the user is required to provide their kiosk membership account number to complete the transaction and to set up delivery. Thus, Hansen does not provide a convenient system for receiving parcels from an undisclosed or unknown variety of sources for use by a group of persons residing in a common geographic location.

The system described in the Gokcebay patent places locker systems in various locations such as convenience stores, gas stations, and metro stations. These lockers are available to a multitude of vendors and customers for deliveries and reservations. The patent indicates that the on-line customer making a purchase can be granted access to the “locker application software” and can allow the customer to select the locker site and locker type. Similar to Hansen, given the limited access by consumer and delivery company, embodiments corresponding to these systems have not been adopted by the marketplace.

The system described in the Komei patent is designed to accept package deliveries, from a number of different delivery companies, for the residents of an apartment building. A receipt is printed by the delivery person and inserted into the mailbox of the recipient, which is later used by the recipient in retrieving the article from the locker. The system relies on the existence of a mailbox and an error free placement of the slip into the correct mailbox by the delivery person.

Karsoo et al. describes a system for distribution of mail in an office complex, for example, wherein the mailboxes are accessed by use of an access card. Similar to a door access control system, the card can be re-programmed (in case of dismissal of an employee, for example).

There are currently a few large e-commerce retail companies that employ a similar type of locker system that addresses the delivery and pick-up of only the products they offer on-line. The customer is required to establish an account with that particular retailer and purchase products from their selection of items. The product is then delivered to one of their locker systems that is located near the customer.

Each of the above examples and those known presently employed do not provide an efficient, integrated, open system for the management of packages, including receiving parcels from an undisclosed or unknown variety of sources for use by a group of persons residing in a common geographic location. Embodiments described herein may provide a shared locker space, while maintaining the security associated with a dedicated retrieval area. Embodiments described herein may also provide efficiency, reduce error, and improve parcel management for the tenants, landlord, and/or delivery company.

### SUMMARY

The present invention is a computerized locker system that facilitates an efficient process for the delivery and pick-up of parcels to multi-tenant locations, such as multi-unit residential housing communities and multi-tenant commercial buildings. The users of embodiments described herein may include residents/tenants who are the recipients of parcel deliveries and a multitude of delivery couriers who deliver the parcels. Embodiments described herein may provide a secure locker system with computer controlled user accessibility and electronic notification and tracking functions for the purpose of delivering and picking-up parcels.

In an exemplary embodiment, an electronically networked and internet connected set of lockers of various sizes are described including an internet connected computer with an external user touch screen display monitor, the computer for use in storing, manipulating and retrieving both parcel recipient pertinent information and parcel delivery tracking information, and a cloud-based storage for receiving, storing, and/or communicating the parcel recipient pertinent information and/or parcel delivery tracking information from the computer.

### DRAWINGS

Embodiments of the present invention are disclosed with reference to the accompanying drawings and are for illustrative purposes only. The present invention is not limited in its application to the details of construction or the arrangement of the components illustrated in the drawings. The invention is capable of other embodiments or of being practiced or carried out in other various ways. Like reference numerals are used to indicate like components.

FIG. 1 illustrates an exemplary locker station according to embodiments described herein.

FIG. 1A illustrates an exemplary block diagram of an exemplary control system for embodiments of the locker station described herein.

FIG. 2 illustrates an exemplary network information flow diagram according to embodiments described herein.

FIGS. 3A-5 illustrate exemplary processing flow diagrams for an exemplary system configuration, parcel delivery, and parcel pick-up. These flow charts illustrate exemplary algorithms programmed in hardware, software, or a combination thereof and executed by the system to perform exemplary functions as described herein.

FIG. 6 is an exemplary modular locker system as described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Disclosed herein is a system of electronic smart locker compartments to be placed in multitenant locations, such as residential housing communities (such as apartment complexes, on-campus university housing, or other multi-unit dwelling, and multi-tenant commercial buildings, for the ease, convenience, and security of delivering and retrieving parcels. Other locations may benefit in which a community resides in close proximity such as gated communities, business complexes, etc. Each locker station consists of a set of individual lockers of various sizes, each with an electronic controlled release operated door latch in communication with a computer. Each locker station may include one or more input device, output device, sensors, etc. The computer comprising at least memory for storing computer instructions and a processor for executing those instructions. The computer and software are used to store, retrieve and manipulate delivery courier and parcel recipient pertinent information and parcel delivery tracking information.

In an exemplary embodiment, the locker station includes sensors for detecting the presence of a parcel within an individual locker. Sensors may include internal infrared sensor, pressure sensor, camera, etc. The locker station may also include an external touch-screen display monitor and/or scanner (bar code reader) that are electronically connected to an internal computer. The touch-screen and scanner may be used as input/output devices to retrieve and provide delivery and tracking information.

In an exemplary embodiment, information stored on the internal computer's server is backed up to a cloud-based storage via the internet. For example, each electronic smart locker station may comprise a specific database file identified by electronic locker number and IP address. The database file has a direct relationship to its location and authorized group of users, which include parcel recipients who are residents/tenants and delivery company couriers.

In an exemplary method of using the system, an authorized courier may input his/her company identification and the pertinent parcel information through the touch screen and the software selects a specific locker compartment. An electronic notification (e.g., email or text message) may be sent to the resident/parcel recipient, along with an access code or other instructions allowing them entry into the locker to conveniently retrieve their parcel.

These and other aspects of the present invention are disclosed below, in the drawings, the description, the appended claims, and the attached appendixes.

Although embodiments of the invention may be described and illustrated herein in terms of parcel delivery and pick-up, it should be understood that embodiments of this invention are not so limited, but are additionally applicable to delivery and/or retrieval of any object through a localized location. Furthermore, although embodiments of the invention may be described and illustrated herein in terms of individual locker systems, it should be understood that embodiments of the invention are also applicable to other storage locations, devices, and mechanisms.

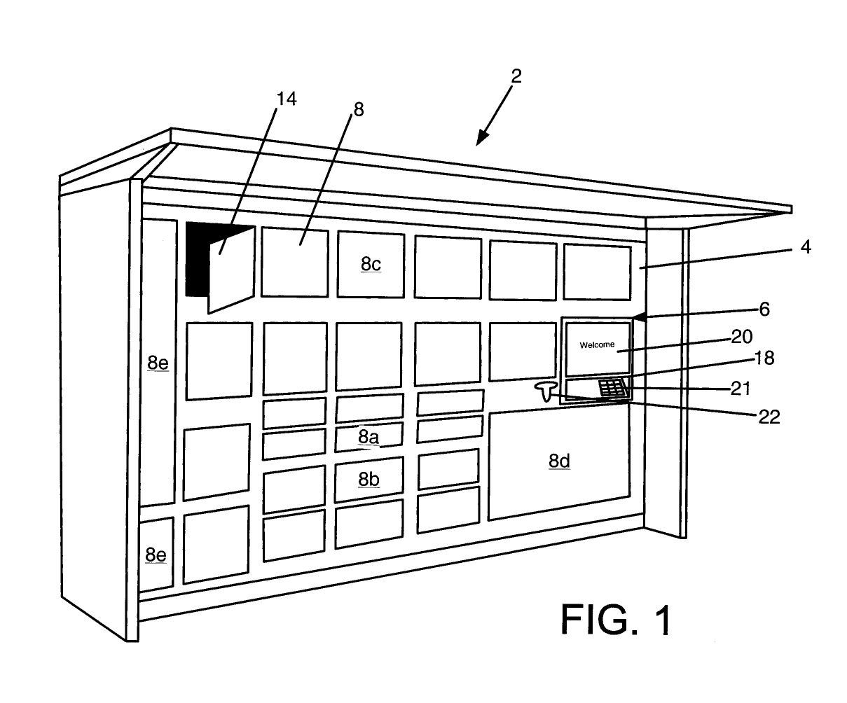

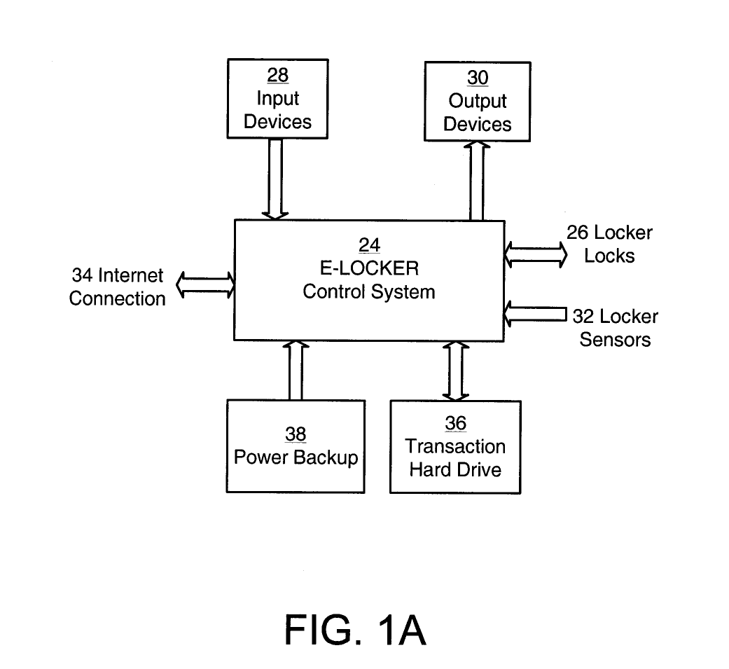

In FIG. 1, an exemplary embodiment of a parcel locker station 2 for use with a novel system and method is illustrated. Locker station 2 is designed to provide a secure parcel delivery, storage, and pick-up solution to a variety of users. Such users are contemplated to be individual consumers, corporate consumers, delivery companies (e.g., United Parcel Service, Federal Express, United States Post Office, etc.), retailers (e.g., Best Buy, Sears, Wal-Mart, etc.), and Internet retailers or “e-tailers” (e.g., Amazon.com, etc.). Since retailers and “e-tailers” typically have their products delivered by a delivery company to a consumer's residence or place of business, kiosk 6 can provide a valuable conduit through which consumers, delivery companies, retailers, and e-tailers harmoniously conduct business transactions.

Locker station 2 comprises a structural skeleton 4. Skeleton 4 provides the necessary framework to permit the locker station 2 to be a free-standing unit. The skeleton 4 and/or components of the locker station are designed to withstand the environment in which it is intended to be used. For example, as storage of parcels, the components of the locker station are strong enough to support the typical or above-average expected weights of associated parcels that fit within the system of lockers. The locker stations may also be strong enough to withstand customary tampering, to create a secure holding facility for delivered parcels. The locker station and components thereof may also be coated, treated, or composed of materials to withstand the environment, such that the locker station may be kept inside or outside, as space and convenience of the station may dictate. In an exemplary embodiment, skeleton 4 comprises steel that has been wrapped in an insulating material, such as a layer of twelve-gauge (12) metal. In some embodiments, skeleton 4 can include a baked-on layer of enamel finish to provide protection from the elements (e.g., rain, sleet, snow, wind, etc.). As such, locker station 2 may be used in both indoor and outdoor applications. As shown in FIG. 1, locker station 2 can be artfully decorated to provide the locker with an aesthetically pleasing façade or veneer. Locker station 2 may alternatively be integrated into a building structure or other structure and not free-standing.

Locker station 2 is configured to support a plurality of locker compartments 8. Locker compartment 8 can vary in size, shape, and geometry. Typically, locker compartments are constructed of a sturdy material, such as stainless steel. Each locker compartment can include a door 14 which can be opened to access the interior of the compartment and permit deposit or retrieval of a parcel therein. As shown, the locker station 2 may include various sized lockers, such as small 8a, medium 8b, large 8c, and extra large 8d. Specialized lockers 8e may also be offered, such that the shape, size, and/or interior features are designed for one or more specific functions. For example, a locker may include a hanging bar and be longer vertically to accommodate hanging garments. A locker may also be climate controlled, such as humidity regulated, temperature controlled (such as for a refrigerator or freezer). Therefore, perishable items, such a groceries may be delivered.

Referring back to FIG. 1, a separate door 14 covers individual and separate locker compartments 8, such that each space is segregated from other spaces. The doors 14 therefore permit parcel compartments 8 to be selectively and individually opened and closed. The doors and/or locker compartments may be fitted with an electronic release system. Doors 14 are preferably constructed of stainless steel and covered with a baked-on enamel finish. The doors and locking system may include any combinations of electronic and manual controls. For example, the doors may include traditional lock and handle systems working in conjunction with the electronic release system to permit access to individual lockers in case of electronic failure and/or as an override feature to permit access by an system administrator. The doors may also be completely controlled by the electronic locking system interfaced through the computer. The door locks may also be controlled through the electronic system, while still including a handle for manual opening and closing. The doors 14 can be artfully decorated.

Each locker station 2 is associated with at least a computer 18. Computer 18 can comprise a processor and memory for storing instructions executed by the processor. The computer 18 may include connections for input and output devices. For example, an external user “touch” screen display monitor 20 and numeric key pad 21 may be electronically connected to the computer. Touch screens are typically computer screens that are sensitive to pressure applied thereto. As such, a touch screen permits information to be received by the computer 18 and/or an, for example, stored in an associated computer database, when user touches the display monitor.

Computer 18 permits input, storage, and retrieval of information for access by resident/tenants and delivery company couriers. The information can include resident/tenant such as their name and address, delivery company information such as company name and courier name and identification and product information such as the UPC code and merchandise brand names. Information of the kind described above is exemplary and for illustrative purposes only. In short, any type of information related to the parcel package (e.g. tracking information) and parcel recipient pertinent information (e.g. recipient name, address, preferences) is contemplated by the invention.

Preferably, computers 18 can be mounted internally and positioned in the center section of the locker station 2. However, the computer 18 including output and input devices may be positioned wherever convenient for the recipients. The touch screen display monitor 20, as an example of an input and output device, can also be placed in the center section of locker station 2, although it can be externally positioned to provide residents/tenants and couriers access to the computers housed within the locker station 2. Also, as shown in FIG. 1A, scanner 22 can be incorporated into locker station 2 and associated with computer 18. Scanner 22 is capable of reading identifying indicia (e.g., UPC codes) to identify parcels delivered by couriers. Display monitor 20 and scanner 22 can control access to parcel compartments 8 by activating or deactivating locking system associated with doors 14 of locker station 2.

In addition, a sensor can be positioned in each compartment 8 or associated with one or more compartments 8 to detect when a package is stored inside. In an exemplary embodiment, the sensor may be an electronically controlled infrared sensor that can be connected to computer 18. Storage information can then be relayed from the sensor about the locker and sent to the computer, and can be recorded. In an exemplary embodiment, the storage information can inform which lockers a courier may have access to when delivering parcels. For example, couriers delivering parcels cannot have access to compartments 8 when the sensor detects that a parcel is already inside. A signal may be sent from the computer preventing the locking system from activating an occupied locker and/or indicating the occupancy of a locker so a given locker is not selected or considered for selection by a courier. The computer can then select an empty compartment 8. The sensor can also have capabilities to detect, record, and/or send an alert notification when the doors 14 are opened or closed.

In addition, one or more cameras can be positioned on locker station 2. Such cameras can comprise digital cameras, motion sensitive cameras, infra-red cameras, and the like. In an exemplary embodiment, motion can be detected when a compartment is opened and/or closed, the console interface is engaged, or other interaction with the system, such that the cameras can be activated during use of the system. Other motion sensors may be set up to detect motion within a given proximity of the system, thus turning the cameras on. The cameras, and associated recorders (not shown), can be used to capture and record an image (e.g., of an individual delivering or picking-up a parcel) to verify that a parcel has in fact been placed inside or removed from a parcel compartment 8 within locker station 2.

It is further contemplated that an alarm system can be associated with locker station 2. If an unauthorized entry is made into one or more parcel compartments 8, or if compartments are damaged or vandalized, the alarm system can activate and release a notification via the cloud to the home office. In preferred embodiments, the notification can alert and/or trigger a response from appropriate personnel. Therefore, if locker security, functionality, or even its overall appearance has been breached, compromised, or in some other way altered, off-site (i.e., a site that is removed or otherwise away from the individual locker) appropriate personnel are notified. In one embodiment (not shown), a centralized, off-site information data center monitors locker security to ensure that only authorized use of the locker takes place.

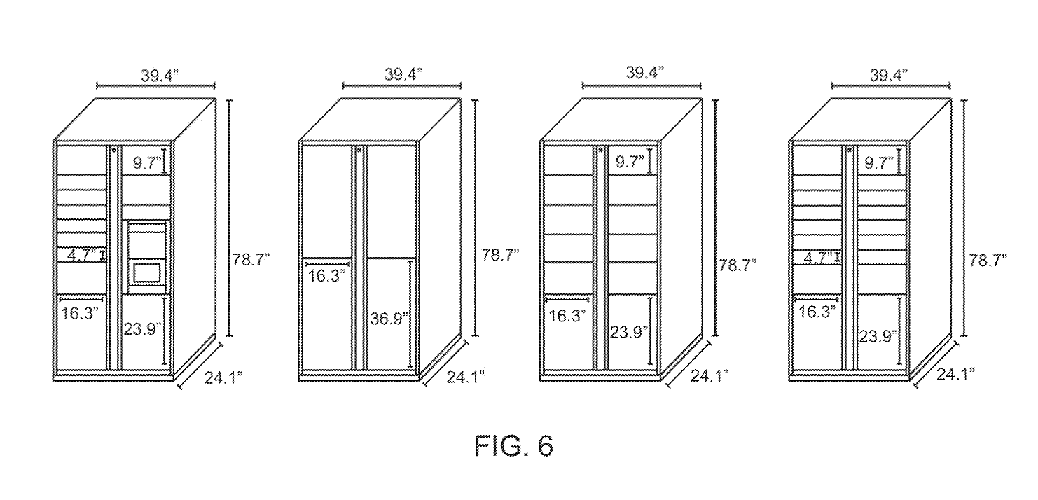

FIG. 6 illustrates an exemplary modular locker system according to embodiments described herein. As shown, the locker station may be composed of one or more modular units. The modular units may have the same outer dimensional configuration, such that one or more modular units may be substituted for any other one or more modular units. The modular units may be factional variations of the dimensions of one or more other modular units. For example, a largest unit may have a dimension x-y-z, while a small unit may have a dimension ½x-⅓y-z such that two of the smaller units may be positioned horizontally, and three units stacked vertically to fill the same space as the largest unit. Therefore one or more combinations of modular units may be substituted for one or more other combination of modular units while still occupying the same footprint or space restriction. The modular units may provide different combinations of lock configurations, such that a property manager may select a desired combination of locker sizes, configurations, and/or functions. The modular units may communicate with a host unit that includes the locker station computer. The host unit may supply power and communication links to dependent units coupled directly or indirectly thereto. The modular units may be wired or wirelessly coupled to provide power and/or communication between the units.

FIG. 1A illustrates an exemplary system block diagram of the supporting computer 18, lockers 8, and other locker station 2 system components. In an exemplary embodiment, locker station 2 includes a control system 24. The control system 24 may facilitate actuation of the lockers, interaction with system, including retrieving and sending information to the system, etc. The control system 24 may comprise one or more computers. The internal computer 18 may be part of the control system 24. One or more other computers, processors, memory devices, etc. may also be used in addition to or as an alternative to the international computer 18. For example, some or all of the processing functions may be handled externally from the locker station 2 and communicated to the locker station 2 over a connection, such as internet connection 34.

The control system 24 may retrieve information from a user through one or more input devices 28 and/or output devices 30. Input devices 28 may include touch display, optical reader (such as bar code scanner or QR code reader), camera, key pad, key board, mouse, touch screen, touch pad, buttons, switches, or other means to provide information to the system. Output devices 30 may include display, printer, communication links (such as near field, Bluetooth), storage devices (such as disks, cards, etc.) or other methods to provide information from the system to a user or other system or device. The input devices and output devices may be separate or integrated into one or more components or consoles. In an exemplary embodiment, the input/output devices include a touch screen, bar code scanner, and/or alphanumeric keypad. The control system 24 retrieves information from the input devices 28 and provides information to the user through output devices 30.

Control system 24 may also include an internet connection, network connection, and/or other wired or wireless means of communication (e.g., Bluetooth, LAN, etc.). The internet connection 34 permits the control system to communicate with remote locations and/or systems. Therefore, one or more locker station 2 may be in communication with one or more other locker station, one or more other remote kiosk, and/or one or more other computers. The connection may permit a user to update, control, send/retrieve information, monitor or otherwise interact passively or actively with the locker station remotely. In an exemplary embodiment, two or more locker stations may communicate over the connection and work in conjunction as a system. For example, if one locker station is full, the locker station may communicate to another locker station associated with the same community and determine if available space is available in a locker station in close proximity. A user may then be directed to another locker system in proximity to the first system having available lockers. In an exemplary embodiment, one or more kiosks may be in communication with the locker station. Therefore, for example, if delivery is made outside of the locker system (such as if a package is too large to fit in an available locker), tracking of the package to the management office may be entered through the remote kiosk and all delivery information tracked through the same database of the locker station. The remote kiosk may have features and components the same as or similar to the computer and/or control system of the locker station, but with or without the physical lockers. The locker station may also communicate over the communication link so that one or more users, such as residence, property managers, and/or currier services may enter, edit, or retrieve information about recipients, tracking history, parcels, availability, maintenance, or other related functions of the system.

The control system 24 may also retrieve information from the locker station, including, for example, the state of the lockers 26, or other locker sensors 32. Locker sensors may include sensors to determine whether a given locker is occupied by a parcel, whether the door is open or closed, whether the system or a component is operational, capturing images, detecting motion, detecting a presence of an object or user, etc. The sensors may be used for example to detect the presence of a user so that the control system can turn on security camera, illumination, wake the system from an energy saving mode, etc. The sensors may be used to detect the presence of a parcel within a locker such that the locker may be used when not in use, and kept secure or unavailable for additional parcels when in use. The sensors may be used to determine whether a door is open or closed such that a user may be alerted to close a door that was not properly secured after delivering or retrieving a parcel. Sensor may also be used to detect system failures, anomalies, or one or more desirable or undesirable conditions, such as for maintenance, monitoring, etc. of the system.

The control system 24 may also communicate with the locker locks 26 such that one or more lockers may be selectively opened by the control system 24. The locks may be in a normally closed position. The locker doors may be coupled to the locker station, such that when the lock is released, the door is configured to open. The door may be motorized, or spring loaded to bias the door in an open position. The lock may be configured to automatically engage whenever the door is returned to the closed position. The lock may be electronically or mechanically controlled.

The locker station 2 may also include memory or hard drive 36 such that the transactions associated with the locker station may be stored. The transaction hard drive 36 may comprise one or more memory devices that store information about the tracking history of one or more parcels, the use of one or more of the lockers, or combinations thereof. For example, the transaction hard drive 36 may comprise a database that retains information about parcels delivered to each recipient and/or locker, including recipient, the delivery date and time, the pick-up date and time, duration of storage, delivery company, delivery personnel, weight of parcel, size of parcel, locker used, origin of parcel, parcel tracking history, and combinations thereof. The database may be stored locally at the locker station and/or stored remotely, such as a remote server accessed through the internet connection, or a combination thereof. The database may be copied and/or backed up, such that all or a portion of the database resides locally at the locker station, and all or a portion of the database resides remotely, such as through a cloud storage service.

Each locker station 2 can also contain a power backup system 38. For example, each locker station 2 can include battery backup system for the computer 18 in the event of a loss of commercial AC power. In an exemplary embodiment, the battery backup system comprises two 12-volt batteries positioned inside the cabinet near the computer 18. Other backup systems may be used to provide a power source in the event of main power loss. For example, the system may use batteries or a generator either configured as a local, dedicated power supply, such as internal to and supporting the locker system, or as a shared, external, or common power supply shared among other resources such as the management computer systems or lighting systems, etc.

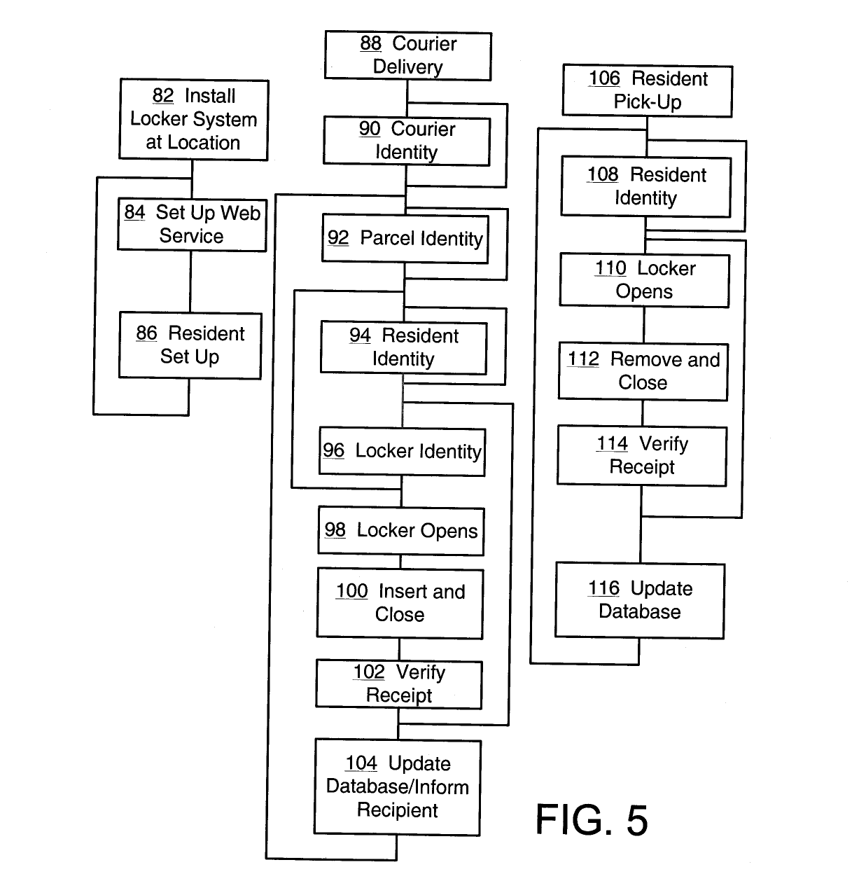

FIG. 5 illustrates an exemplary method of storing and retrieving parcels according to embodiments described herein.

### Installing and Registering the System

At step 82, a property or community selects a locker station and installs the locker system at a desired location. The locker station may be selected in any dimensional configuration including different combinations of individually sized lockers, height and width restrictions, integrated or stand a-long configuration, modular or integrated, etc. The locker is installed and connected to a power supply and network or communication link. For example, the locker station may be pulled into an AC power supply and internet connected through a wired cable or wireless router.

At step 84, the system administrator, such as a property owner or manufacturer of locker station, sets up the web service. The system administrator navigates to an internet location through a computer system, either on the locker system or independent therefrom. The web service presents one or more web pages displaying one or more templates to obtain information about the system and its users. For example, the system administrator, may be prompted to enter property or location information for the locker station, resident addresses available for use with the locker station, associated fees or billing information for use of the locker station, access codes for users of the system. The access codes may be set, for example, for those desiring to open and/or deposit parcels within the system. For example access codes may be entered for one or more courier providers, property office personal, etc. Codes may be randomly selected or manually entered. For example, a courier service may request a specific access codes such that the same courier may have the same access code for all locker stations along their delivery route. The system administrator may enter specific access codes and associated user information related to the given access code.

At step 86, the residents of the location using one or more locker stations may be set up. Residents may navigate to a website on a computer coupled to the internet. The website, through one or more web pages, displays one or more templates for data entry by the resident. Through the resident registry, the resident may provide information to the system including, but not limited to, name, address, payment information, phone, e-mail address, preferred notification method, disability requirements, preferences, other occupants, etc.

Once at the website, the user may select or enter a location and/or address to associate the resident to a given locker stations. For example, from the registration step of 84, the locker system may be associated with a community name or address. Therefore, the resident can select a given location, for example, from a drop down menu, through entry of a text box, through selection of a location on a map, or otherwise select an appropriate locker station. The resident may then be prompted to select an address associated with the locker station as already entered in the web registration process of step 84. The resident may then be prompted to enter their user information, such as, for example, user name, password, credit card or other payment information, e-mail, notification preference, disability, or other preference for use with the system.

The resident may also be prompted to directly enter their address, and the system may correlate the resident to a given locker station without the need to individually select a given locker station. For example, the resident may navigate to a resident registration website. The website may display one or more templates for retrieving information, such as, for example, resident name, resident address, e-mail address, phone number, credit card information, additional occupants in the residence, notification preferences, disability requirements, or other user preferences or information. From the entered resident address, the system may identify a given resident to a given locker station or property registration from step 84.

System administrators, residents, and/or other persons registering with the system may perform similar functions directly at the locker station by providing similar information through one or more templates presented to a user at the locker station display. The locker station may use the same or similar website for registering users, or may register users locally at the locker station without the support of a remote server or network.

The lockers are therefore powered and coupled to the network, and the desired property and residence information supplied either through a website or the locker system. The information from the websites and/or locker system may be communicated, such that all system components have real-time or semi-up-to date information. For example, the locker system may download resident information entered and stored in a database on a remote service to a local database on the locker system. Information stored or entered at the locker system may similarly be uploaded and stored at a remote server or database. In an exemplary embodiment, the information stored at the locker station is sufficient to permit access and use of the system if internet connection were temporarily terminated, such that a currier could deliver parcels and presently stored parcel may be retrieved. For example, residence identities, available addresses, courier and administrator access codes, user preferences, and access codes for held packages may be stored locally at the locker station. However, historical data, including use of lockers, tracking information, resident data, etc. may be stored at a remote server location or other remote location for statistical analysis, information retrieval, etc. through the website interface. Historical data unnecessary to the operation of the locker system may be deleted or overwritten locally at the locker station to save storage space and reduce processing times, but backed-up or stored at a remote storage location such as a remote server or database. For example, historical data or retrieved packages may be maintained for a given interval, such as one week to a month, and then deleted or overwritten.

The various users may access the system through the web service and edit, add, delete, or otherwise modify or view their preferences, settings, information, etc. For example, the web service may provide a portal that permits a user to view parcel history or payment history. Parcel history may including one or more tracking identifiers for a parcel including delivery date, holding time (i.e. the amount of time stored in a locker station), origin (i.e. sender of the parcel), courier service, recipient, locker, pick up date, property identity. Payment history may include charges made for service, licensing, storage, etc. The viewed information may depend on the user, such as a resident may view their own information, while the property manager may track use with respect to the property residence.

### Delivering a Parcel to a Locker

After installation and registration, the locker station is ready to use. During use, at step 88, a courier has a parcel for a resident associated with the locker station. The courier may attempt drop off directly with the resident or delivery only to the locker station. The system may display at the locker station one or more screens to permit the courier to select a locker to accommodate a parcel for delivery. The system may permit the courier to merely identify a desired locker size or may include additional security features, such as identify themselves, identify a resident, etc.

In an exemplary embodiment, at step 90, the courier identifies themselves to the system. For example, the courier enters an access code entered into the system at the registration step 84. The courier code identifies the courier company and/or the courier person. The system then verifies the code based on codes stored in the system. If the code is not found, then the system may provide an error message and request reentry of the access code. If the code is found, then the system may proceed and permit access to a locker and/or receive additional information from the courier.

In an exemplary embodiment, at step 92, the system may permit identification or other information about the parcel to be entered. For example, the system may then permit or prompt the courier to scan or enter information regarding the parcel, such as its bar code or QR code, size, weight, etc. The system may be configured to read the bar code or QR code or manually accept an identifier or number associated with the parcel through an alphanumeric keypad, touch screen, or other input device (such as rotary knob and button). In an exemplary embodiment, the system may communicate with the respective system of the courier service, such that information about the parcel, including its tracking history, size, weight, etc. may be automatically retrieved. For example, the system may log in or communicate over the internet connection to a courier system and provide the associated parcel number and retrieve parcel information from the courier system. The locker station may also or alternatively store the parcel information, such as its bar code, size, weight, etc. locally, such as into a database.

In an exemplary embodiment, at step 94, the system may permit identification or other information about the recipient of the parcel. For example, the courier may be prompted to enter the resident identity. The courier may be provided with one or more selections or drop down options for identifying a resident, or entering resident information by an alpha-numeric entry, or combinations thereof. For example, the courier may identify a recipient by the address, including a building or apartment number, and/or by a name. The system may include different sequential screens or prompts to identify a recipient. For example, the system may prompt the courier for a building number through entry on a numeric entry device or selection of displayed numeric options. After selecting a building, the system may display or request the residence identity associated with the given building.

In an exemplary embodiment, at step 96, the system may permit identification or selection of a desired locker for a given parcel. For example, the courier may be prompted to select a locker size based on the number and size options provided for the given locker station configuration and/or availability. For example, the available lockers may include small, medium, large, and extra-large. If all medium lockers are presently in use, then the locker system may only permit selection of small, large, and extra-large lockers. The system may also permit the courier to make other locker selections, such as row or column. For example, if a parcel is on a dolly, the currier may desire a locker at a similar height to the parcel's position on the dolly. Therefore, the courier may select a locker, if available by indicating a given locker or a row, or height of a desired locker.

The locker selection may be automatically made or options restricted based on the information already available to or retrieved by the system. For example, if a user indicated ADA accessibility restrictions, that limit the height of a locker to below four feet, for example, then if the courier is permitted height selection, the courier may be restricted from selecting a height over four feet. Similarly, if the system has determined that all of the lockers of a given size are in use, then that locker size may not be available for selection. Alternatively, the system may permit the same selections by the courier, but base its locker selection on a set of priority rules such that a given locker is chosen based on the input information, where conflicting selections may be ranked by priority. For example, in the cases of the ADA restriction, the courier may be allowed to select a higher locker location, but when determining which locker to provide for the parcel, the system may give priority to the resident selection of the ADA accessible lockers. When making a priority determination of conflicting selections, the system may or may not provide a notice to the user providing an explanation or notice of the priority of the given selections. For example, a courier may be notified that no lockers are available for the selected criteria, such that the courier does not think the system did not receive or consider the requested input information.

At step 98, after entry of all of the desired or requested information, including courier information, parcel information, and/or locker information, the locker is opened for parcel insertion. The system may selected a locker given the one or more pieces of information entered in one or more of the previous steps. The system may consider size, availability, resident preferences, courier selections, etc. to select an available locker for deposit of a given parcel. Once selected, the control system unlocks the door of the locker. The door may be manually opened or automatically opened after it is unlocked. If manually opened, the locker system may display the locker number and/or location to the courier to identify the locker to deposit the parcel.

At step 100, the courier can insert the parcel into the opened locker and shut the door. The system may then permit or prompt the courier to complete the transaction and/or repeat the process for additional parcel.

The system may also include additional mechanisms to ensure proper functioning. For example, at step 102, the system may verify proper receipt of the parcel. The system may include one or more sensors to determine whether the locker door was properly secured and/or whether a parcel is present within the closed locker, and/or whether the parcel within the locker matches the characteristics of that identified at step 92. For example, the system may include a sensor to detect the presence of the parcel. The system may include an infrared sensor to determine whether an object is within the locker space. The system may also or alternatively include one or more sensors to determine whether the door is shut and/or whether the lock is engaged. Therefore, once courier is finished with the transaction, the system may verify that a parcel is in the desired locker, the locker door is secured and locked. The system may also include a sensor to determine the weight of the parcel and compare the weight to that of the entered data about the parcel to confirm parcel identify by weight. If any one or more of these features is not confirmed, such as, for example, the system determines that a parcel was not inserted into a closed locker, the system may provide one or more messages to the user.

In an exemplary embodiment, once the locker door is closed, the system verifies the presence of a parcel within the locker. If the system determines that a parcel is present and the door is closed and secured, at step 104, the system updates and saves appropriate information associated with the transaction to the database and provides notice to the recipient. However, if the system determines, for example, that a parcel was not inserted into the locker system, then a notice is displayed to the courier that requests whether a different locker is desired. Therefore, if the courier determines that the provided locker is undesirable for a given reasons, such as an undesirable size or condition, then the courier is permitted to make another locker selection without having to reenter all of the previous courier, parcel, and resident information. Upon acknowledgement of the courier, the system may permit the courier to make a locker selection, and/or may automatically make another locker selection based on previous and/or newly received information from the courier. For example, after the courier indicates a different locker is desired, the system may prompt the courier for a new locker size and/or location. After selection, the system may exclude the previously offered locker from the decision making, and open a new locker for confirmation by a courier.

In an exemplary embodiment, if the courier makes the same locker selection choices (such as size, location, etc.) used to select the rejected locker, the system may indicate a problem with the previously supplied locker. For example, if a courier does not choose a provided locker based on its condition, such as if its interior is undesirable based on previously inserted contents, the system may flag that locker for inspection by maintenance personnel and/or property management. The system may store the information for retrieval by maintenance personnel or may send a notice to one or more administrators. The notice may provide a log of events that led to the notice and/or suggest a course of action, such as suggested maintenance and cleaning of an identified locker. Alternatively, the system may prompt the courier to enter a reason for rejecting a given locker, such as mistake, condition, maintenance, etc. Depending on the selection, the system may respond by logging the selection, sending an appropriate notice to one or more persons, etc.

After a parcel is deposited within a locker, the system may update its respective databases, and/or provide notice to a recipient. The system may, for example, indicate that the locker is no longer available for future deliveries. The locker location may be correlated, such as in a database, to the parcel and intended recipient. The system may alert the recipient of the presence of the parcel within the locker station. For example, based on the preferences of a resident at step 86, the system may provide an email and/or text message that a parcel is ready for pick-up. The notice may include information necessary to retrieve the parcel from the locker station. The notice may also include other information for the user. For example, the notice may include an access code or other identifier or instructions for retrieving the parcel. The notice may also include a warning of fees that will be incurred and dates or times that those fees will be incurred. Other delivery information may also be included such as the delivery service, the locker number, and/or locker location. The notice may also include information about the system, such as website or phone numbers to get assistance in case of a problem or inability to pick up a parcel.

In an exemplary embodiment, individual transactions are stored in memory in a database local to the locker station. Once all transactions of the courier are completed, (or in between one or more transactions of the courier), the system is configured to push the stored information to the web service. The web service is configured to store a back-up of all retrieved information. The service is also configured to push an e-mail or text, based on resident preferences (step 86), with an appropriate message, based on web service set up (step 84). The notice information may include transaction identifiers, tracking information, bar code numbers or other parcel identifiers, delivery date and time, and other desired or configured information. The notice may include one or more instructions for retrieving the parcel. For example, the notice may include an access code relating the user to a given parcel and/or locker storage.

Picking Up a Parcel from a Locker

At step 106, the resident or recipient may then pick up the parcel at their convenience. At step 108, when the resident comes to the locker station, the resident may identify themselves to the system. In an exemplary embodiment, the recipient enters the code supplied in the notice of receipt from step 104. The system then looks up the code and determines the locker correlated to the supplied code. Alternatively, the recipient identifies themselves and enters a given code unique to the resident, such as a passcode or other identifier. The system then looks up the code and determines which lockers contain parcels being held for the given resident. The system may permit the user one or more alternatives to enter the requested codes. For example, after entering a code, the system will verify that the code is valid. If it is valid, then the system proceeds to step 110. If the system verifies that the code is invalid, then the system may repeat the request. The system may include a safety such that a user is only provided a limited number of attempts before the user must request assistance from the system administrator or until the system is reset at a later time.

At step 110, the system opens the lockers corresponding to a given resident and/or access code. The lockers may be opened all at once if one or more lockers are assigned to the same resident, access code, and/or may be opened sequentially such that the lockers are only accessible one at a time. After the locker opens, the recipient can remove the parcel and close the locker door.

In an exemplary embodiment, at step 114, the system verifies receipt of the parcel. For example, the system may use one or more sensors to determine that the parcel was removed from the locker and/or that the locker door was secured and locked. If the sensors indicate the presence of a parcel and/or the locker door remains open, a notice or warning may be provided to the user and/or system administrator. If the recipient shuts the door without removing the parcel, the system may request whether the user intends to store the parcel. The system may be configured to provide storage of a parcel at given storage rates. A notice of the respective storage rate may be displayed to the recipient and/or notice provided through the selected notification preferences.

In an exemplary embodiment, the system may be configured to charge storage fees of received parcels. The system may be configured to automatically charge a recipient the respective storage fee periodically (e.g. daily or weekly) or once the parcel is removed from the locker station. The system may be configured to provide notice and/or charge a recipient a storage fee whether or not the recipient attempts to retrieve the parcel depending on the set up parameters at steps 82, 84, and 86. The system may be configured to have an escalating or varied storage fee schedule. For example, the system may not charge if a parcel is retrieved within a first time frame, such as a few days. The system may then charge a first storage fee if the parcel is not retrieved within the first time frame. The system may then charge a larger second storage fee if the parcel is not retrieved within a second time frame, such as, for example, a week or more. The system may also charge surcharges or set different storage fees based on the use and/or expected use of the system. For example, during holiday schedules, when deliveries are expected to increase and storage within the locker station is undesirable, the system may be configured to charge a surcharge or premium storage fee. The storage fee schedule may be set at the set up stage, such as step 84, and/or may be updated or edited through the system administrator website at any time. A notice of charges may be sent to all residence when a change is made, and/or to those residence currently storing parcels within the locker station.

In an exemplary embodiment, if the parcel is too large for any of the provided or available lockers, then a message may be displayed to the courier to take the parcel to the management office, to another locker station, and/or deliver to the recipient directly. The system may include a kiosk or computer at the management office or at the other locker station, such that the transaction may be completed or confirmed from the second location. Therefore, information may be retrieved and/or stored at the first location and pushed to the web service. When the courier arrives at the second location, the courier may indicate that the transaction is pending and retrieve the information already entered at the first location. Therefore, delivery at a second location may be expedited. Delivery at a management office, residence, or other location may also be entered through the web service, such as through a web site accessible through the internet. After completion of the transaction, the information may be stored at the server database to permit a complete record and/or tracking history for a given parcel within the system. The system may be configured to send out a notice to the recipient indicating that the parcel was left at the residence and/or at the management office.

In an exemplary embodiment, after a recipient retrieves a parcel with a generated access code, the system may terminate use of the access code and not reuse the code for a specified amount of time, or until all unused variations of an access code have been used. The system may store information locally at the locker station and/or remotely such as at a server accessed over the internet. The system may update one or the other systems depending on the redundancy desired, and/or available storage space at one or both locations. For example, the system may update all information from the locker station to the server database at periodic intervals and/or after completion of one or more transactions. The system may similar update the locker station from information stored or entered through the web service upon entry of specific information and/or at periodic intervals. For example, the locker station may be updated as soon as new residences are entered or old residences are removed from the web service. However, the locker station may not be updated with parcel delivery information when a parcel is delivered to the management office, or may only be updated periodically with select desired information, such as at the end of the day.

Exemplary embodiments described herein provide a web-service that is used in conjunction with the locker station. The locker-station communicates with the web-service through the internet or other network communication connection. One or more web-services interfaces may be provided depending on the identity of the user. For example, a resident may be provided a first interface, while the property owner/system administrator may be provided a second interface. The web-service permits a user to retrieve, add, update, or delete information from the system. For example, the system administrator may add or remove residence and/or recipients/occupants from the system as residence move in and move out. The residence may update preferences, including notification preferences, and contact information. The system may provide history information, such as tracking information for specific parcel, and/or use trends for a given resident and/or the locker system. Maintenance requests or notifications may also be sent and/or received through the web service. The web service may permit searching of the database and/or display of requested information in one or more forms, such as tables, graphs, charts, etc.

Exemplary embodiments may include any combination of desired features as described herein.

In an exemplary embodiment, the courier information may not be necessary, such that the locker station may be used to deposit and/or store parcels by anyone. The system may permit a user to enter in payment information, such as a credit card, so that the locker station may be used as a temporary storage facility. The system may also permit any user to indicate a desired locker size and recipient information such that anyone can deliver parcels to any residence of the community. For example, if a neighbor borrows and item and wishes to return it to the neighbor owner when the owner is not present, then the borrower may request a locker at the locker station or through the web service, and identify the owner resident. The system can then open a locker based on the requested locker size. Once the borrowed object is placed inside the locker and the door shut, a notice can be sent to the receiving resident of the presence of an object for pick up. Similarly, the locker station may be used by the property manager to delivery items to the residence such as paint, keys, resident documents, etc. Similarly, a courier may drop off parcels without needing to be added through the system administration or being assigned a courier code if such a feature is desired by the community and/or courier service. Accordingly, the steps described herein may be used in any combination or sub-combination, and no step is necessary to practice the invention. Instead, the steps described herein are exemplary only of illustrated embodiments

In an exemplary embodiment, the system may permit a resident or recipient to return a parcel for pick up by a courier. The system may permit a user through the locker station or web service, or indicate a desire to return a parcel. If the parcel was delivered through the locker station, the recipient may be able to retrieve the parcel delivery information including the courier. The system may prompt the recipient to confirm information as previously stored from parcel delivery, or permit the recipient to enter new information, such as new courier selection information. If entered through the web service, the recipient may be given an access code to enter at the locker station to open a locker. The system may then work similar to that described herein with respect to courier drop-off, but the recipient is the courier and the courier identifier is the access code provided through the web service. The locker station may acknowledge the access code and automatically bypass selection of a recipient as the recipient may have been added through the web service, and/or may be indicated directly on the parcel. The system may or may not permit the user to identify the parcel and/or the locker. For example, the system may automatically make selections based on previously used criteria when the parcel was delivered or may permit the recipient to make new or additional selections. The system may also permit the recipient to indicate a pick up or return directly at the locker station. The system may prompt the user for parcel identity, locker identity, but instead of resident identity, the system will prompt the resident to identify the courier that needs to retrieve the parcel. The system may then provide an alert or notice to the courier that a parcel is ready to be retrieved or picked-up. Alternatively, the next time the courier is delivering packages, the courier may be notices of a parcel for pick up.

Exemplary embodiments described herein may be used for various parcels, including packages and even dry cleaning, groceries, etc. For example, one of the couriers may be a dry cleaning service that is given access to one or more of the lockers for pick-up and delivery of drying cleaning. The lockers may be fitted with a bar across the top to support garments on hangers. When the courier indicates a drop off, the system may know that the courier is a dry cleaner through the set up selections and therefore only open lockers fitted with the hanging bar. Alternatively, at locker selection, step 96, the courier may indicate a desire for a locker including the bar for hanging garments. The system may then also permit a resident to drop off clothes through one of the altered lockers or through any locker if the garments are not given to the dry cleaner hung up. The resident may be provided a dedicated identification number, such as that provided to couriers, so that the resident may repeatedly enter the system and indicate a parcel (including clothes) are ready for pick up. Alternatively, the resident may be provided a temporary or single-use identification number, such as through the management office and/or web service, so that the resident may drop off a parcel for courier pick up at single use intervals. The system would follow a work flow similar to that for the courier delivery of steps 88-104, where the resident identifies themselves, identifies a desired locker, identifies the courier needed to pick up the parcel; the system opens the locker; the resident inserts the parcel and closes the locker; the system verifies receipt; and the system sends a notice to the courier (either through text, email, fax, etc. or through a notice on the display screen of the locker station when the courier returns to deliver parcels). Other specialized lockers may be available for other deliveries such as groceries, flowers or other perishables that may need a climate controlled environment. The user depositing the specialized merchandise into the locker may be prompted or may indicate a desired environment for the merchandise, either generally or specifically. For example, the courier may indicate “refrigeration” or “freezing” or may be able to enter specific temperature, humidity, or other controllable parameter. The system may provide a confirmation or warning to the user indicating whether the requested parameter is achievable. The system may also provide available options for selection by the user.

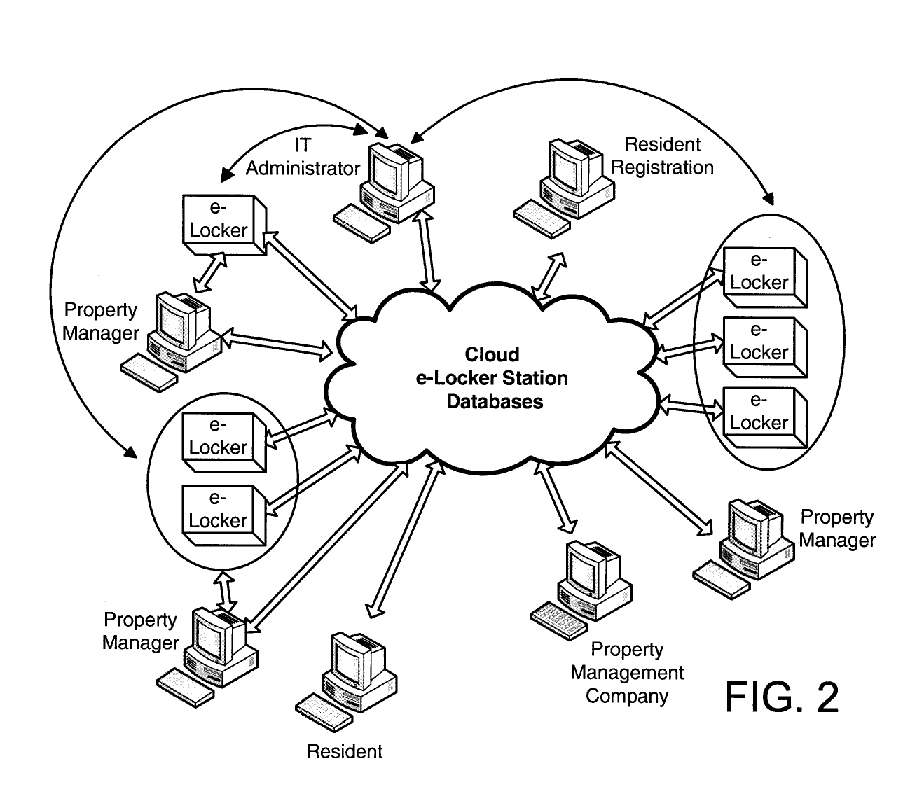

FIG. 2 illustrates an exemplary system overview of various locker stations, at the same or different properties, and the interaction of different users. As shown, a property management company, property managers, and residents may interface with the web service through one or more computers. The communication may be through any networked connection, such as the internet. One or more locker stations may be located at different or the same property. Lockers at the same property may be grouped such that they may communicate with each other through the web service, local network, or dedicated communication paths (wired or wireless). Grouped locker stations may offer additional storage space as described herein. The locker stations may also be coupled to a local network of the property, such that a remote computer, i.e. that of a property manager, may directly communicate with the locker stations. Alternatively, or in addition thereto, the property managers may communicate with the locker stations through the web service. In this case, information may be retrieved from the locker station and stored in the cloud databases, while the property manager can view and retrieve the stored information from the cloud databases. Therefore, the property managers may have limited access to the locker stations itself. In this case, the cloud acts as a firewall to the locker station, such that security at the locker station is maintained. A system administrator, such as an IT administrator may access the directly with the locker stations through the internet and/or through the web service. In case of technical problems, the IT administrator may access the locker stations through a portal of the web service or through another communication link supported by the internet. Therefore, the IT administrator can have remote access to both the web service and the locker stations to handle remote maintenance.

The system may segregate the web service, such that users may only view information based on their user status. For example residents may only view their own personal deliveries and payment histories. Property managers may only see information relevant to their property. Other specific identity details may also be limited. For example, property managers may only know the identity of a user when a parcel is kept over a pre-determined period of time or once charges for storage are incurred.

The system may also permit a user to generate reports. For example, the system may collect and/or aggregate data from one or more users to provide usage information. The system may, for example, provide an average storage length; the present, average, historical, or other status information of the individual lockers; usage profiles, such as running averages over sequential limited temporal periods. The system may delineate based on locker size, location, or usage. For example, the system may provide a report that indicates the medium sized lockers are full 98% of the time, while smaller lockers are only used 12% of the time. The information may be used to select a different locker configuration and/or identify additional lockers when the present locker stations are at capacity. Usage notifications, such as warning of capacity, may be automatically generated, and/or may trigger charges for continued storage. The system may provide notifications for all recipients when or before a charge is incurred based on their notification preferences.

In an exemplary embodiment, the networked lockers can be operated as follows:

As illustrated in the system diagram of FIG. 2, the owner, resident, and couriers are registered into the system. The landlord/owner enters into an agreement to purchase the appropriate number of locker stations 2 composed of any given combination of lockers and/or locker sizes, configurations, orientations, etc. needed for the property and can pay a flat fee or a monthly software access fee. The landlord/owner can be responsible for registering and managing user (i.e. individual, family, company, or organization) information. Management of the information may include adding, deleting, and updating user information. The exemplary information available for operation of the locker station 2 are the resident/tenant name, address, e-mail address, cellular phone number, credit card information, and any Americans with Disabilities Act (ADA) notifications.

The landlord/property owner may also have the responsibility of registering the delivery company courier information, which may include the delivery company name, courier name, identification code and contact phone number.

Residents may register on-line at a given website address. The registration process may include entering a name, phone number, email address and credit card for the occupants of the apartment. All occupants may be registered in order for the delivery company to locate an appropriate resident.

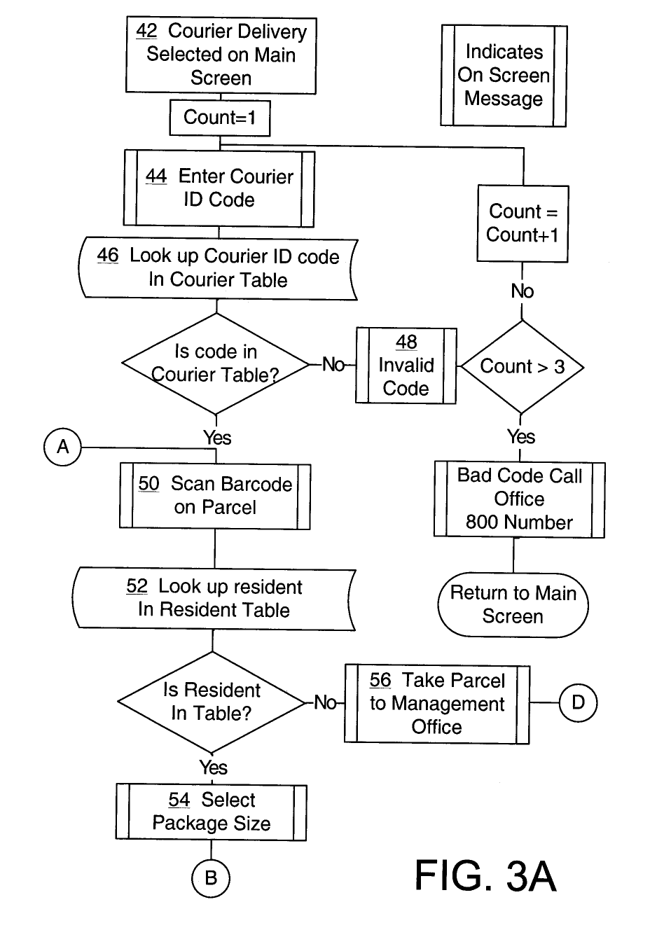

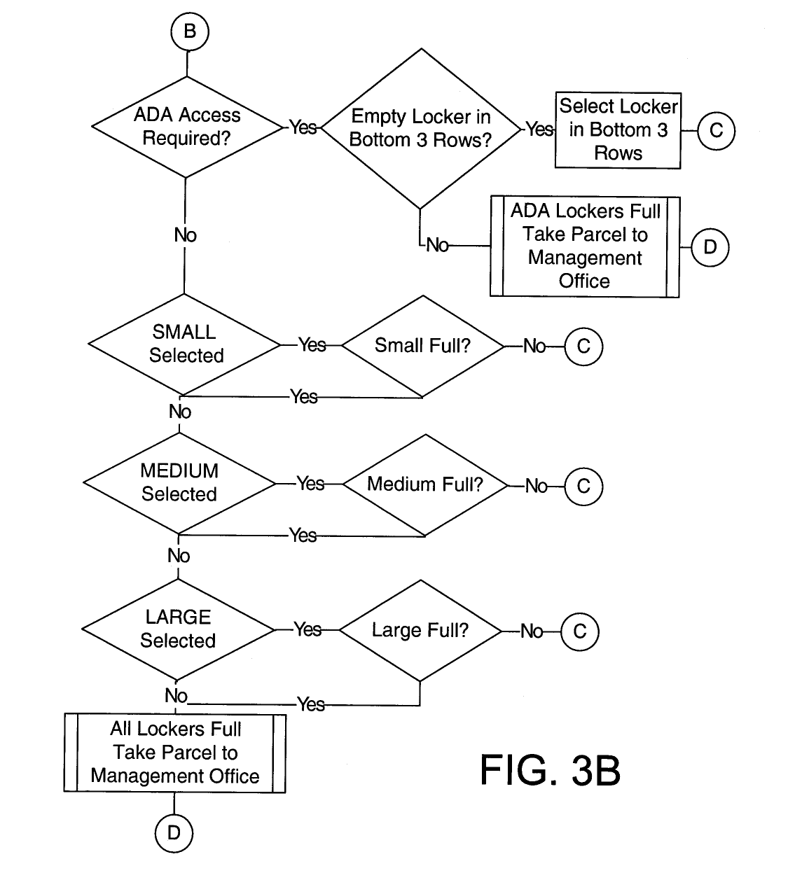

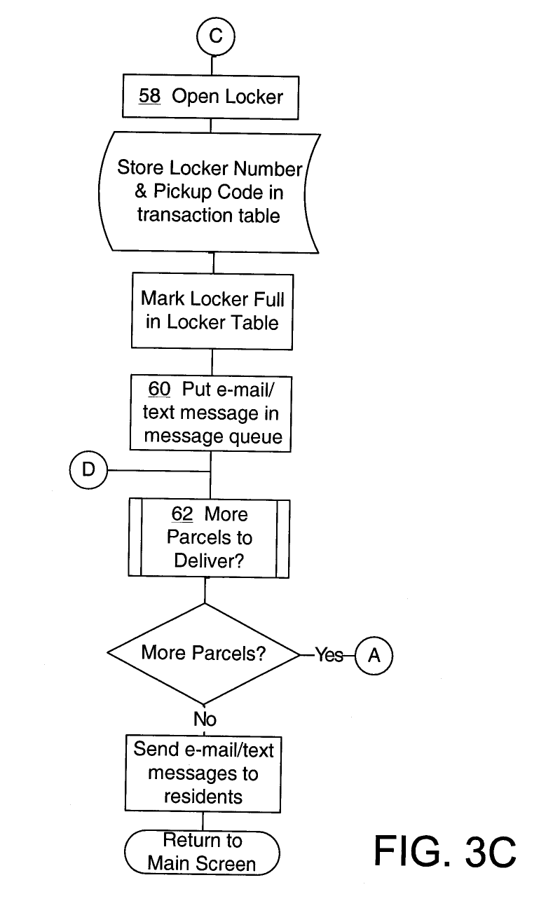

A resident/tenant request delivery of a parcel to their resident/business. The delivery company courier can first attempt to deliver a parcel to the recipient. If the courier is unsuccessful, he/she can deliver the parcel to the on-site locker station for secure storage until pick-up by the resident/tenant. FIG. 3 illustrates an exemplary flow for delivery of a parcel to the locker station 2.

In an exemplary embodiment, a delivery person has arrived at the locker station 2 with a parcel. At step 42, the touch screen monitor 20 displays a “Welcome” screen along with two selection buttons: “Parcel Pickup” and “Courier Delivery.” The delivery person selects the “Courier Delivery” option and the software transitions to the “Delivery Companies” screen. There are four delivery company selections buttons (FedEx, DHL, UPS, USPS), in addition to three other selections (Staff, Other, Back) displayed on the screen. After the courier selects his/her delivery company the software transitions to the next screen which displays a text box and full keyboard. At step 44, the courier is required to enter his/her courier identification code into the text box. At step 46, the software queries the computer 18 database 36 to verify the information provided by the courier. If the software finds that the courier information is invalid, at step 48, the following message is displayed: “Invalid Code Entry—The access code entered is invalid. Please try again or contact support at (phone number). A “Back” selection button is positioned on the bottom of the page and can allow the user to return to the prior screen.

If the software determines the courier information is valid, at step 50, then the “Scan Parcel” screen is displayed, along with a manual entry and back button selection. The courier is required to scan the parcel, which is the preferred method of data entry, but a manual entry is available. Scanning the parcel may provide the name of the parcel recipient.

If the bar code scan is successful, the software transitions to the “Select Parcel Recipient”. If the bar scan is unsuccessful, then the courier may manually enter the information and select the “Next” button to move forward to the “Select Parcel Recipient” screen.

Next, at step 52, the “Select Parcel Recipient” screen can display a text box at the top of the page with the resident's name as shown on the parcel. Under the text box are ten selection buttons which can display the names of residents in apartments with multiple residents. The courier selects the resident name from one of the buttons. If one of the resident's names listed on the screen does not match the name on the parcel, the “Cancel” button is selected and an error message tells the courier to return the package to the shipping hub and the software goes to the “More Parcels to Deliver” screen.

If the name on the parcel matches with the registered resident name, then the “Select Parcel Size” screen appears at step 54. If the resident requires accommodations (ADA), during registration, resident can select the box for packages to be delivered to the bottom three rows of lockers. The “Select Parcel Size” screen has the following selection buttons: “Small, Medium, Large, Very Large, and Too Large.” If the courier selects the “Too Large” button, at step 56, the software displays a new screen with the following message: “Oversized Parcel—Deliver to Management Office” and a “Continue” button.

If the courier selects any of the other sizes, the software can transition to the “Courier Action” page. The software can select an available locker and send a command to activate the electronic release system that secures the selected locker door 14. At step 58, the door 14 can pop (swing) open and the screen can display a left or right directional arrow pointing towards the locker. In addition to the directional arrow is the following message: “Locker is Now Open—Insert parcel into open locker and close door when finished” and a “Continue” button.

After placing the parcel into the locker compartment 8, the infrared sensor confirms a parcel is inside and the door 14 is closed. After verifying these actions, the software assigns a random six character access code to that locker and sends the access code via e-mail or text message to the registered resident, at step 60.

Upon selecting the “Continue” button, the software transitions to the “More Parcels to Deliver” screen, at step 62. This screen offers a “Yes” and “No” selection buttons. If the courier selects “Yes” the software returns to “Scan Parcel” screen. If the selection is “No” the software returns to the “Welcome” screen.

FIG. 3B illustrates an exemplary algorithm for determining/selecting a locker for use by a currier. The selection may be based on various parameters including the availability of lockers as detected by one or more locker sensors, the condition of the locker such as open/closed/jammed/broken/etc., the inputs of the currier including parcel size, information stored in the system, such as resident preference, needs (disability (ADA) accessible). Once the algorithm is completed, such that an appropriate locker is chosen, the system then proceeds with FIG. 3C in which the locker is opened and/or the parcel is indicated as undeliverable to the system and should be sent to the management office.

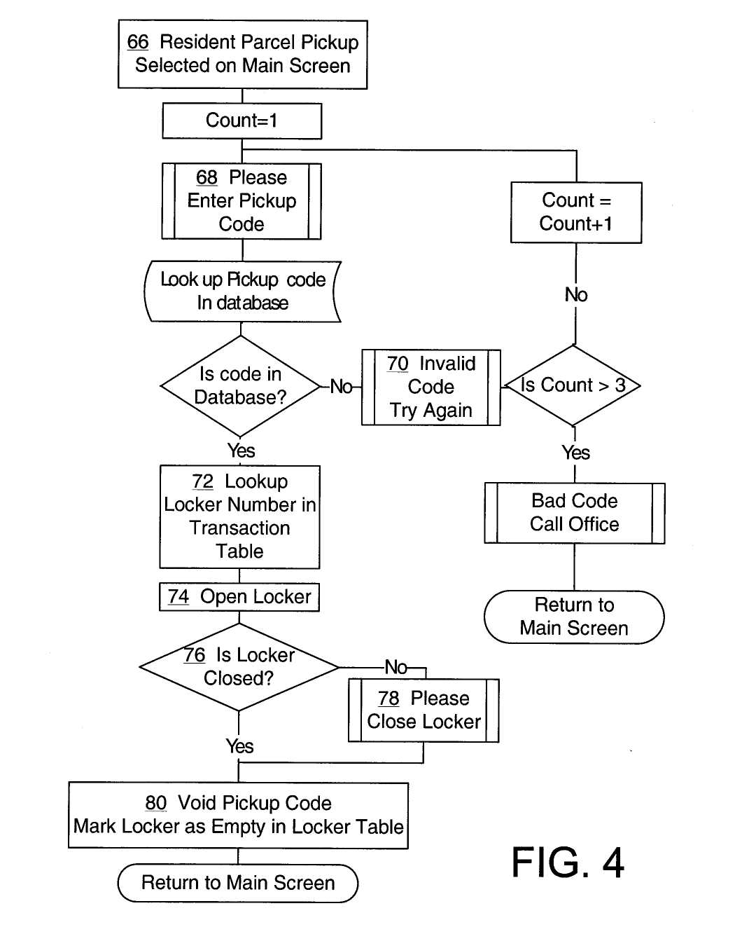

As illustrated in the flow diagram of FIG. 4, a resident can retrieve the delivered parcel from locker 2. In a preferred embodiment, the resident has arrived at the locker where the parcel has been delivered and stored.

Locker station 2, by virtue of computer 18 and touch screen monitor 20, at step 66, prompts the resident at the “Welcome” screen with two selection buttons: “Parcel Pickup” or “Courier Delivery”. The resident selects the “Parcel Pickup” option and the software transitions to the “Enter Pickup Code” screen, at step 68, that displays a text box and full keyboard.

If the resident enters an invalid access code, at step 70, an error screen is displayed with the following message, “Invalid Code Entry—The pick-up code entered is invalid. Please try again or contact support at (telephone number). A “Back” selection button is positioned on the bottom of the page and can allow the user to return to the prior screen.

The resident enters the provided six character access code. If the proper access code is entered, at step 74, the software sends a command to activate the electronic release system 16 that secures the locker door 14 of the locker compartment 8 in which the parcel is stored inside and associated with the access code as retrieve from database at step 72. As the door 14 mechanism is being released, the touch screen monitor 20 transitions to a logo screen, in addition to a left or right directional arrow pointing towards the open locker door 14.

The resident retrieves the parcel from the locker compartment 8. At step 76, the software checks the status of the locker door and obtains information from the compartment's infrared sensor to determine if the parcel is still inside. If the software detects the door has been left open after twenty seconds the touch screen monitor 20 can display the following message, “Please Close Locker” as illustrated at step 76.

After the parcel is removed and the locker door is closed, the software can update that particular compartment locker status to “vacant.” At step 80, the vacant status of a locker places it into the selection cue allowing the software to select it upon a request of delivery of another parcel. The access code used to enter the locker is also voided and not available for use again for a determined amount of time.

Following the “Please Close Locker” screen, the software transitions to the “Thank You” screen. This message can be displayed for ten seconds and then return to the “Welcome” screen.

As shown in the process diagrams described herein, one or more control loops may be incorporated into the system, such that additional security may be had. For example, when entering information to access the system, such as currier identification and/or access code information, the system may comprise a counter such that only a desired number of attempts, (for example, 3) are permitted within any given period of time, or until needing to be reset by an administrator. Any number of attempts may be permitted and programmed by a user, system administrator, or manufacturer.

Although not shown in the flow diagram, cameras can again be activated, as earlier described, to capture images of the customer using the kiosk and/or retrieving the package from the compartment. These images can be recorded and maintained within one or more databases as documentation that the parcel was retrieved, was retrieved by a particular person, and the like. Again, the cameras can provide a security benefits such as eliminating or reducing claims that parcels were never received, damaged, and the like.

The system is shown and described comprising a computer. The computer may have a processor, memory, and input/output devices. The computer stores non-transitory machine-readable media on the memory that is executed by the processor to perform described functions. The system described herein performs a number of functions, for example, detecting the presence of parcels, determining the condition of the locker system (the door open/closed, jammed, or security breach, or appearance alteration, malfunction conditions, etc.), alerting a resident of a parcel, alerting a condition of the locker system, input/output information to a user, system controller, etc. Each of these functions may be performed by hardware, software, or a combination of both. The software may be non-transitory machine-readable media stored on the computer memory and executed by the processor. The functions may be performed by a central computer coupled to the locker system in conjunction with one or more pieces of hardware, such as sensors, locks, screens, etc. The functions may be separated and performed by individual, dedicated devices, or as an integrated system, or combinations thereof. The system may also include a network, internet, or cloud access to one or more other computers, servers, or electronic hardware/software components. Features may be dispersed over one or more of these devices.

The present invention has been described as a particular system. However, other forms and constructions of the present invention may be used. For example, the present invention may be considered and may be implemented as: parcel storage system, a method of securing a parcel for delivery and retrieval, a secure product procurement method, a method of receiving parcel packages, a method of providing delivery data for a parcel package, a delivery locker system, a Graphic User Interface (GUI) for a delivery locker system, a final mile delivery solution, a final mile solution for transporting goods to an end user, a method of delivery for use by a shipping service, a parcel delivery system for use by a shipping service, a parcel delivery locker for use by a shipping service, a secure storage locker for picking up parcels delivered to the locker by a shipping service, a secure, e-commerce transportation, information, and logistics solutions for the delivery and pick-up of parcel packages, as well as an online shipping solution, among others.

Moreover, specific illustrations of control screens and process logic are described. However, any combination of user interface, input/output controls, etc. may be used to suggested herein in any form and/or combination described herein. Therefore, although specific steps are described providing specific selections, displays, input options, etc. to or from a user, any equivalent means for retrieving the same or similar information to or from the user may be used. The system is generally configured to permit a delivery user to identify a recipient, open a locker, leave a parcel, and send a message to the recipient. The system is also generally configured to permit the recipient to retrieve their parcel by opening a specific locker associated with a parcel intended for the recipient. The display options and/or features may vary to accomplish the desired objectives and/or features.

Despite any methods being outlined in a step-by-step sequence, the completion of acts or steps in a particular chronological order is not mandatory. Further, elimination, modification, rearrangement, combination, reordering, or the like, of acts or steps is contemplated and considered within the scope of the description and claims.

Where the invention has been described with reference to illustrative embodiments, it is recognized that equivalents, alternatives, and modifications, aside from those expressly stated, are possible and within the scope of the present disclosure. Moreover, the exemplary embodiment describes multiple components and features for an application in apartment buildings or multiple resident locations. Embodiments are not so limited. The components and exemplary embodiments may be combined in any combination include one or more features as described herein. The features and/or components may be combined, integrated, subdivided, duplicated, repeated, reconfigured, etc. all of which are still within the scope of the present disclosure.

For example, the exemplary system described herein identifies a user by an access code entered into the system through the touch screen or key pad. Other identification methods may be used. For example, the system may include biometric identifiers, such as a finger print scanner. In this case, the system need not provide an access code to deliver or retrieve a parcel. For example, the recipient may be identified when the parcel is deposited in the locker station, and a notification sent to the recipient to retrieve the parcel. The system knows the recipient identity through the biometric marker. Therefore, in this case, the recipient only needs to scan themselves and the system automatically retrieves the necessary locker, and opens the door without additional input from the recipient. Electronic identifiers may also be used, such as smart cards, phones, etc. such that an identity of the user is known and communicated to the system for verification. Access systems, including proximity and smart cards may be incorporated into embodiments described herein. Therefore, if a resident already uses a proximity card to access facilities of the residence (i.e. such as a pool or fitness center), that same card may be used to identify the resident to the locker system. Identifiers may also be electronically made and stored on a smart phone. For example, a digital code may be sent to a user with the notification. Through near field communication (NFC) or Bluetooth, the phone many communicate the code to the locker station to confirm identity.

The lockers may include one or more sensors for detecting the configuration of the locker including the condition of the door (open/closed/jammed) and/or the presence of a parcel. The sensors may be integrated or separate. Specific components are similarly disclosed herein to perform various functions. However, the identified components are not intended to be limiting. Instead, these components may be separated, integrated, divided, replaced, or reconfigured into other devices/components that can accomplish the same function. For example, IR sensors are used to detect the presence of a package and/or condition of the door, however other sensors such as pressure sensors may be alternatively used. Other sensors include other light based sensors, laser, sound, electromagnetic, pressure, strain, stress, electric, piezo-electric, dialectic, magnetic, NFC, contact, closed-circuit, etc. systems configured to detect the desired condition.

The lockers are also shown and described as incorporating a select size/shape configuration, connection to a network, internet, or cloud, interface features such as computer and touch screen, etc. These components may also be modified within the scope of the invention. The system may be isolated for security reasons such that access to the cloud is not permitted. Limited access to local networks may be permitted or not permitted. Various input and output components may also be incorporated such as mouse, joystick, roll ball, touch screen, display, keyboard, number pad, buttons, toggles, touchpad, etc. Any combination of locker size, shape, and configuration is also within the scope of the present invention.

Other applications are also contemplated including use in any area sharing multiple residence, such as office buildings, single or multiple family resident neighborhoods, apartments, hotels, extended stay facilities, shelters, etc. Embodiments may also be used as temporary delivery systems, for example in the case of displaced persons after a natural disaster. The local residence can be registered during the disaster response for obtaining other benefits, and a locker system set up to receive mail/parcels/other goods, etc. at a convenience and local location accessible to displaced persons and delivery personnel.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. A computerized electronic locker system for parcel delivery and pick-up; comprising:
a set of lockers capable of storing goods for users to pick-up or as delivered by users, the lockers being located within the users residential community or at their place of work, the lockers electronically connected to a computer, the computer and software for use in storing, manipulating and retrieving both parcel recipient pertinent information and parcel delivery tracking information; and
the computer and software with an internet connection to communicate with a cloud-based storage to back-up data located on the locker computer's hard drive; and
the computer and software with internet connection for transmitting parcel related data and notifications to parcel recipient;
wherein the parcel can be picked-up by the parcel recipient.

2. The system of claim 1, wherein the locker database also stores information on the size of each locker in the set, and its height above the floor, so as to be capable of accommodating orders of different sizes and users with special requirements.

3. The system of claim 1 wherein the parcel recipient is notified at the parcel recipient accessible computer or wireless cellular phone that a parcel is ready for pick-up.

4. The system of claim 3 wherein the parcel recipient is notified via e-mail or text message.

5. A method for accomplishing at least one of delivery and retrieval of a parcel, the method comprising:
providing a parcel storage locker, the locker comprising a structural framework, the framework capable of receiving and supporting a plurality of parcel storage compartments, each of the compartments having an interior capable of storing a parcel;
providing a computer system that is electronically connected to the locker system, the computer system for use in storing, manipulating and retrieving pertinent information relating to a user and parcel tracking information;
issuing an access code to the parcel recipient for the designated locker system and locker compartment;
receiving (inputting) the access code at the locker system;
permitting access to at least one of the plurality of compartments based on the access code entered so that the user can accomplish at least one of authorized delivering and retrieving of the parcel.

6. A method of receiving a parcel comprising:
providing a locker for receiving and securing a parcel, the locker including a computer and software;
providing a graphic user interface accessible at the locker for receiving parcel related information;
receiving the parcel related information through the graphic user interface;
making a portion of the locker available to securely store the parcel based upon the parcel related information; and
receiving the parcel within the portion of the locker to securely store the parcel.

7. A parcel delivery solution to a multi-unit residential housing community or commercial multi-tenant building comprising:
a plurality of lockers, each of the lockers comprising a plurality of compartments, each of the compartments being capable of storing a delivered parcel and comprising a door, each door permitting access to the compartment and including a locking system therein;
at least one computer and software in operational association with each of the locker systems, the at least one computer capable of accepting information and comprising a computer monitor;
a database in operational association with the computers and software, the database capable of storing and recalling the information associated with use of the plurality of lockers;
wherein a user of one of the plurality of lockers inputs the information into the computer, the computer and software verifying the information, the computer and software actuating the locking system within the door to unlock the compartment, and the user retrieving the delivered parcel from the compartment.

8. The solution of claim 7, wherein the computer screen functions as a touch screen for inputting parcel recipient pertinent and parcel tracking information.

9. The solution of claim 8, wherein input of the information into the computer is accomplished by the user operating the touch screen.

10. The solution of claim 7, wherein the database is associated with at least one of an interact, a world wide web, a phone line, an optical cable, a router, and a server.

11. The solution of claim 8, wherein the information comprises at least one of name, address, phone number, e-mail, parcel number, tracking ID number, delivery company tracking ID number, account number, access number, verification number, delivery address, locker location, and compartment number.

12. The solution of claim 8, wherein the information is input into the computer by at least one of a scanner, a touch screen, a keyboard.

13. The solution of claim 8, where the solution further comprises one or more cameras associated with the lockers.

14. The solution of claim 13, wherein each of the one or more cameras is associated with a recording device for recording images captured by the cameras.

15. The solution of claim 7, wherein the delivered parcel includes at least one of a bar code, a UPC code, a tracking ID number, a delivery company tracking ID number, an indicia associated with a retailer, and an indicia associated with an e-tailer.

16. The solution of claim 7, wherein the user can retrieve the delivered parcel from within the compartment upon e-mail notification.

17. The solution of claim 7, wherein after the delivered parcel is stored within the compartment and the user is provided an access code to enter the locker to retrieve the parcel.

18. The solution of claim 7, wherein each of the lockers is capable of being secured to another locker or an adjacent structure.

19. The solution of claim 7, wherein each of the lockers is capable of being modularly secured to one or more additional lockers.

20. The solution of claim 7, wherein the solution further comprises an alarm system associated with each of the kiosks, the alarm systems providing security to the solution.
